(19) United States
(12) Patent Application Publication
(10) Pub. No.: US 2026/0231214 A1
(43) Pub. Date: Aug. 6, 2026

(54) METHODS AND APPARATUSES FOR SIDELINK CONFIGURED GRANT IMPLICIT ACK/NACK

(71) Applicant: INTERDIGITAL PATENT HOLDINGS, INC., Wilmington, DE (US)

(72) Inventors: Martino Freda, Laval (CA); Faris Alfarhan, Montreal (CA); Tuong Hoang, Montreal (CA); Moon IL Lee, Melville, NY (US); Tao Deng, New York, NY (US)

(73) Assignee: INTERDIGITAL PATENT HOLDINGS, INC., Wilmington, DE (US)

(21) Appl. No.: 19/153,272

(22) PCT Filed: Feb. 13, 2024
(86) PCT No.: PCT/US2024/015638

§ 371 Date: Aug. 1, 2025

Related U.S. Application Data
(60) Provisional application No. 63/484,937, filed on Feb. 14, 2023.

(51) Int. Cl. H04W 74/0816; H04L 1/1812; H04L 5/00; H04W 92/18

(52) U.S. Cl. CPC H04W 74/0816; H04L 1/1812; H04L 5/0053; H04W 92/18

(57) ABSTRACT

Methods and apparatuses are described for sidelink (SL) configured grant (CG) implicit acknowledgment (ACK)/negative acknowledgement (NACK). Methods performed by a first WTRU for SL communication with a second WTRU may include: receiving configuration information for a threshold of one or mor physical sidelink feedback channel (PSFCH) resources; transmitting a transport block (TB) associated with a hybrid automatic repeat request process in a first CG occasion; monitoring PSFCH resources associated with the CG transmission resource, and determining whether each PSFCH resource falls within a channel occupancy time (COT) initiated by the first WTRU; and retransmitting the TB in a second CG occasion, in response to a number of the one or more PSFCH resources that are within a COT initiated by the WTRU being greater than or equal to the threshold, wherein the WTRU has not received an ACK/NACK from the second WTRU for the transmitted TB.

### CROSS REFERENCE TO RELATED APPLICATION

This application claims the benefit of U.S. Provisional Application No. 63/484,937 filed Feb. 14, 2023, the contents of which are incorporated herein by reference.

### BACKGROUND

New Radio (NR) introduced a configured grant (CG) timer for configured uplink grants. Each Hybrid Automatic Repeat Request (HARQ) process has a CG timer that is started when a wireless transmit/receive unit (WTRU) performs a new transmission or a retransmission for that HARQ process. Using the CG timer associated with a HARQ process, the network may not need to send an explicit acknowledgement to a WTRU for successful transmission. In sidelink (SL), there is no need for the CG timer because of the presence of statically configured Physical Sidelink Feedback Channel (PSFCH). Resources are already set aside in SL for HARQ feedback transmission. With sidelink on unlicensed bands (SL-U), however, a receiver (RX) WTRU may not acquire the PSFCH to transmit HARQ feedback due to the failure of Listen Before Talk (LBT). This may result in a transmitter (TX) WTRU performing unnecessary retransmissions, thereby causing congestion and wasting resources. Thus, methods and apparatuses that implicitly assume an acknowledgement (ACK) or a negative acknowledgement (NACK) by the TX WTRU when the RX WTRU have trouble to acquire the channel to send HARQ feedback in SL-U are needed.

### SUMMARY

Methods and apparatuses are described herein for sidelink (SL) configured grant (CG) implicit acknowledgment (ACK) and/or a negative acknowledgement (NACK). In embodiments, a method performed by afirst WTRU for sidelink communication with a second WTRU includes: receiving configuration information for a threshold of one or more physical sidelink feedback channel (PSFCH) resources; transmitting a transport block (TB) associated with a hybrid automatic repeat request (HARQ) process in a first configured grant (CG) occasion; and retransmitting the TB in a second CG occasion, in response to a number of the one or more PSFCH resources that are within the channel occupancy time (COT) initiated by the WTRU being greater than or equal to the threshold, wherein the WTRU has not received an acknowledgment (ACK) or a negative acknowledgement (NACK) from the second WTRU for the transmitted TB. In further embodiments, the method may include monitoring one or more PSFCH resources associated with the first CG grant occasion, and determining whether each PSFCH resource falls within a COT initiated by the first WTRU. In further embodiments, the method may include flushing, based on that the number of the one or more PSFCH resources that are within the COT initiated by the WTRU being less than the threshold and the WTRU has not received the ACK or the NACK, a HARQ buffer; and transmitting, using the HARQ process, another TB in the second CG occasion. In further embodiments, the one or more PSFCH resources are one or more occasions to receive, from the second WTRU, one or more HARQ feedback. In further embodiments, the one or more HARQ feedback are one or more sidelink HARQ feedback. In further embodiments, the method may include wherein the WTRU assumes a receipt of a NACK for the transmitted TB in response to the number of the one or more PSFCH resources that are within the COT initiated by the WTRU being greater than or equal to the threshold.

In further embodiments, a wireless transmit/receive unit (WTRU) includes: a processor; a receiver; and a transmitter, the processor and the receiver are configured to receive configuration information for a threshold of one or more physical sidelink feedback channel (PSFCH) resources; and the processor and the transmitter are configured to: transmit a transport block (TB) associated with a hybrid automatic repeat request (HARQ) process in a first configured grant (CG) occasion; the processor and the receiver are further configured to monitor one or more PSFCH resources associated with the CG transmission resource, and determine whether each PSFCH resource falls within a channel occupancy time (COT) initiated by the first WTRU; and the processor and the transmitter are further configured to retransmit the TB in a second CG occasion, in response to a number of the one or more PSFCH resources that are within a channel occupancy time (COT) initiated by the WTRU being greater than or equal to the threshold, wherein the WTRU has not received an acknowledgment (ACK) or a negative acknowledgement (NACK) from the second WTRU for the transmitted TB. In further embodiments, the processor and the transmitter are further configured to: flush, in response to the number of the one or more PSFCH resources that are within the COT initiated by the WTRU being less than the threshold and the WTRU has not received the ACK or the NACK, a HARQ buffer; and transmit, using a HARQ process, another TB in a second CG occasion. In further embodiments, the one or more PSFCH resources are one or more occasions to receive, from another WTRU, one or more HARQ feedback. In further embodiments, the one or more HARQ feedback are one or more sidelink (SL) HARQ feedback. In further embodiments, the processor is further configured to assume a receipt of a NACK for the transmitted TB in response to the number of the one or more PSFCH resources that are within the COT initiated by the WTRU being greater than or equal to the threshold. In further embodiments, the processor is further configured to assume a receipt of an ACK for the transmitted TB in response to the number of the one or more PSFCH resources that are within the COT initiated by the WTRU being less that the threshold.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2A is a diagram illustrating an example process for sidelink (SL) configured grant (CG) implicit acknowledgment (ACK) and/or a negative acknowledgement (NACK); and

FIG. 28 is a diagram illustrating a further example process for SL CG implicit ACK and/or a NACK.

### DETAILED DESCRIPTION

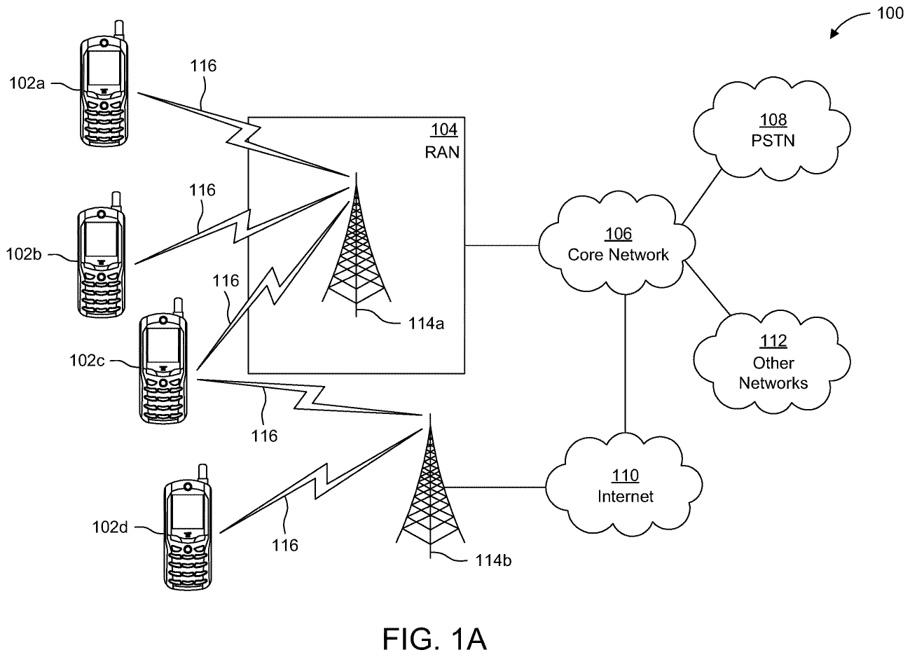

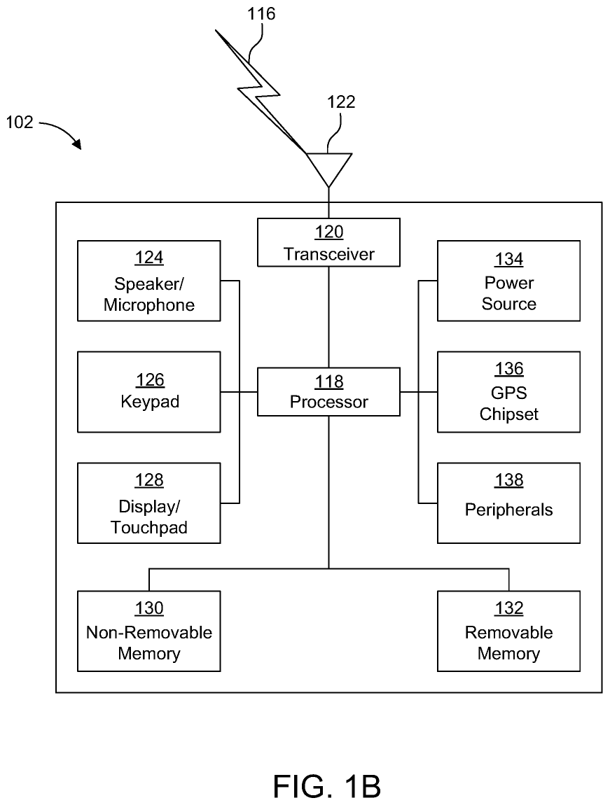

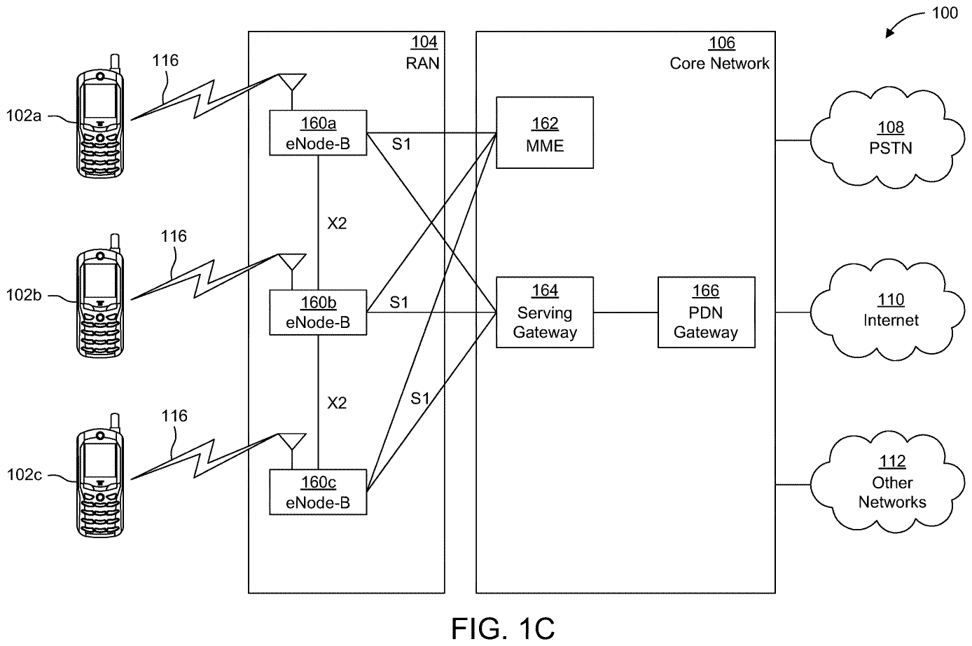

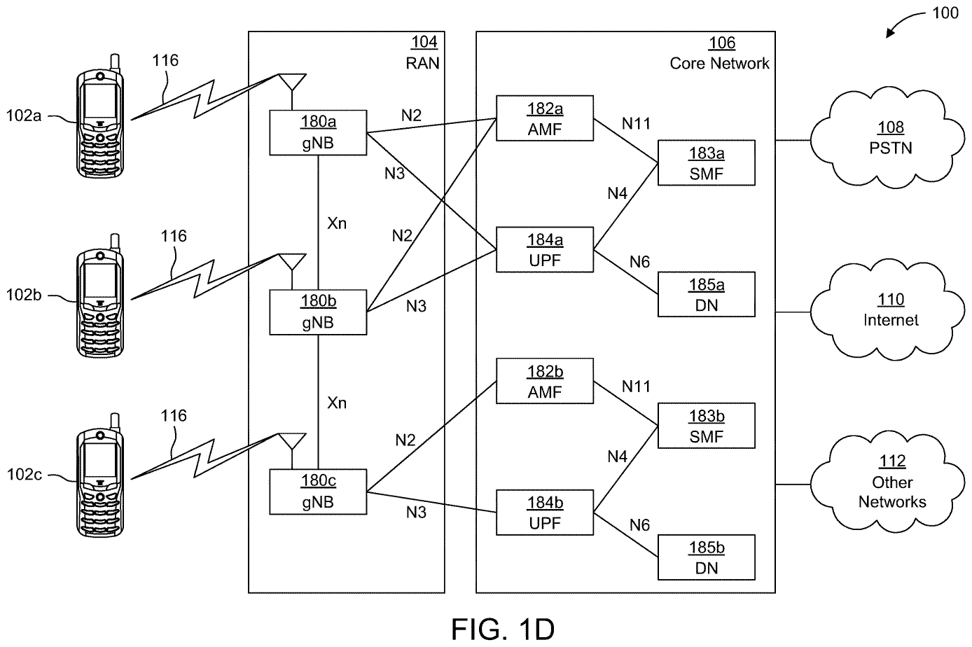

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), singe-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or abase station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cel may further be divided into cell sectors. For example, the cel associated with the base station 114a may be divided into three sectors. Thus, in one embodiment, the base station 114a may include three transceivers, i.e., one for each sector of the cel. In an embodiment, the base station 114a may employ multiple-input multiple output (MIMO) technology and may utilize multiple transceivers for each sector of the cel. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the Ike. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/AP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless inks). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a singe element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an internet browser, a Virtual Reality and/or Augmented Reality (VR/AR) device, an activity tracker, and the Ike. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuraion. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11Af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among al STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 16b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180s, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cel (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or al, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment Direct RF coupling and/or wireless communications via RF circuitry (e.g., which may include one or more antennas) may be used by the emulation devices to transmit and/or receive data.

The following terminologies may be used throughout this disclosure.
ACK Acknowledgement
BLER Block Error Rate
BWP Bandwidth Part
CA Carrier aggregation
CAP Channel Access Priority
CAPC Channel access priority class
CBR Channel Busy Ratio
CCA Clear Channel Assessment
CCE Control Channel Element
CE Control Element
CG Configured grant or cell group
CGRT Configured grant retransmission timer
CGT Configured grant timer
CHO Conditional handover
COT Channel Occupancy Time
CP Cyclic Prefix
CP-OFDM Conventional OFDM (relying on cydic prefix)
CPA Conditional PsCell addition
CPAC Conditional PsCell addition/change
CPC Conditional PsCell change
CQI Channel Quality Indicator
CR Channel Occupancy Ratio
CRC Cyclic Redundancy Check
CSI Channel State Information
CW Contention Window
CWS Contention Window Size
CO Channel Occupancy
DAI Downlink Assignment Index
DC Dual connectivity
DCI Downlink Control Information
DFI Downlink feedback information
DG Dynamic grant
DL Downlink
DM-RS Demodulation Reference Signal
DRB Data Radio Bearer
eLAA enhanced Licensed Assisted Access
FeLAA Further enhanced Licensed Assisted Access
HARQ Hybrid Automatic Repeat Request
LAA License Assisted Access
LBT Listen-Before-Talk
LCH Logical Channel
LTE Long Term Evolution e.g. from 3GPP LTE R8 and up
LTM L1/2 triggered mobility
NACK Negative ACK
MCG Master cell group
MAC Medium access control
MCS Modulation and Coding Scheme
MIMO Multiple Input Multiple Output
NR New Radio
OFDM Orthogonal Frequency-Division Multiplexing
PCell Primary cell
PCI Physical cell identity
PHY Physical Layer
PID Process ID
PO Paging Occasion
PRACH Physical Random Access Channel
PSCell Primary SCG Cell
PSFCH Physical Sidelink Feedback Channel
PSS Primary Synchronization Signal
QoS Quality of Service
RA Random Access (or procedure)
RACH Random Access Channel
RAR Random Access Response
RCU Radio access network Central Unit
RF Radio Front end
RLC Radio Link Control
RLF Radio Link Failure
RLM Radio Link Monitoring
RNTI Radio Network Identifier
RO RACH occasion
RRC Radio Resource Control
RRM Radio Resource Management
RS Reference Signal
RSRP Reference Signal Received Power
RSSI Received Signal Strength Indicator
SCell Secondary cell
SCI Sidelink Control Information
SCG Secondary cell group
SDU Service Data Unit
SL Sidelink
SpCell Special Cell*
SR Scheduling Request
SRS Sounding Reference Signal
SS Synchronization Signal
SSS Secondary Synchronization Signal
SWG Switching Gap (in a self-contained subframe)
SPS Semi-persistent scheduling
SUL Supplemental Uplink
TB Transport Block
TBS Transport Block Size
TRP Transmission/Reception Point
TSC Time-sensitive communications
TSN Time-sensitive networking
UAV Uncrewed Aerial Vehicle
UCI Uplink control information
UL Uplink
URLLC Ultra-Reliable and Low Latency Communications
WBWP Wide Bandwidth Part
WLAN Wireless Local Area Networks and related technologies (IEEE 802.xx domain)

In New Radio (NR), a WTRU can be configured with multiple configured grants (CG) of type 1 (e.g., RRC configured and activated) or type 2 (e.g., RRC configured and DCI activated). In each case, the configured grant resource may be allocated without a DCI that schedules the specific HARQ process to transmit in the UL For this reason, a formula was defined for mapping the HARQ process to the CG resource to ensure that the network can unambiguously determine which HARQ process was transmitted in the CG resource. For configured uplink grants, the HARQ process ID associated with the first symbol of an UL transmission may be derived from the following equation:

$$HARQ Process ID = [ floor ( CURRENT\_symbol / periodicity ) ] modulo nrofHARQ - Processes \qquad Equation 1$$

Similar to the Uu interface, SL configured grants may define a mapping from HARQ process ID to CG resource as the following equation:

$$HARQ Process ID = [ floor ( CURRENT\_slot / PeriodicitySL ) ] modulo sl - NrOfHARQ - Processes + sl - HARQ - ProcID - offset \qquad Equation 2$$

NR introduced a CG Timer for configured uplink grants. Each HARQ process has a CG timer that is started when a new transmission or a retransmission for that HARQ process is performed by a WTRU. The purpose of such timer in Uu was to avoid the need for the network to send explicit acknowledgement for successful transmissions performed in a CG by a HARQ process. Specifically, a WTRU starts the CG timer for a HARQ process when the WTRU performs transmission for that HARQ process in an UL configured grant (or in a dynamic grant used for retransmission). When the timer expires, and the WTRU (e.g., during the running of the timer) did not receive and HARQ feedback for the HARQ process in the form of a dynamic grant for retransmission, the WTRU can assume that the transmission was successful and then proceeds to flush the HARQ buffer.

On the other hand, the network can send a dynamic grant to force a WTRU to perform retransmission (e.g., within the dynamic grant) of the HARQ process associated to a configured grant. In that case, the network identifies the HARQ process in the DCI sent for the dynamic UL grant A WTRU that performs retransmission of a HARQ process associated to a CG restarts the CG timer, regardless whether the retransmission is performed in a CG or in a dynamic grant.

New Radio-Unlicensed (NR-U) and the possibility of Listen Before Talk (LBT) failure introduced an issue associated with the CG timer. Specifically, it may be possible that following a WTRU's transmission in an uplink CG, the network is unable to acquire the channel to transmit a NACK using a dynamic grant due to LBT failure. To allow the use of the CG Timer in NR-U while avoiding cases where the WTRU incorrectly interprets a NACK as ACK due to the network's inability to transmit HARQ feedback due to LBT, autonomous retransmissions controlled by a configured grant retransmission timer (CGRT) may be introduced for NR-U. Specifically, a WTRU is allowed to autonomously perform retransmission for a HARQ process (i.e., another CG that is not the CG associated to the HARQ process determination formula) as long as the CGRT has expired. The CGRT is started when the WTRU successfully performs transmission, and the WTRU can perform autonomous retransmissions of a HARQ process only when the CGRT has expired. This ensures that the WTRU gives the NW enough time to access the channel and send acknowledgement.

Because a WTRU can perform autonomous retransmissions, CG-UCI is included in all CG transmissions so that the WTRU can include the HARQ process ID with the CG transmission (and inform the network of the HARQ process and retransmission status).

Configured Grant-Downlink Feedback Information (CG-DFI) was also introduced to allow the network to explicitly ACK/NACK a CG (e.g., to avoid unnecessary retransmissions as a result of CGRT expiration.

In sidelink, there was no need for introduction of CG timer because of the presence of statically configured PSFCH. In other words, resources are already set aside in sidelink for HARQ feedback transmission, even for CG, so introducing a mechanism to implicitly assume ACK if NACK is not received for some time was unnecessary.

With Sidelink-Unlicensed (SL-U), however, there may be instances where the RX WTRU is unable to acquire PSFCH to transmit HARQ feedback due to LBT failure. This may result in the TX WTRU performing unnecessary retransmissions (e.g., when the RX WTRU was unable to send ACK), thus further causing congestion.

Multiple PSFCH resources associated to a singe TB transmission may be introduced. To avoid resource waste, it may be necessary to allow a WTRU to transmit PSFCH for multiple TB transmissions in a singe PSFCH occasion.

In embodiments, a WTRU may implicitly assume ACK or NACK by the TX WTRU, given that the RX WTRU may have trouble to acquire the channel to send HARQ feedback. For example, implicit ACK/NACK determination by a TX WTRU in SL-U may be introduced to address the issue of the RX WTRU not acquiring the channel to transmit PSFCH, or using the PSFCH resource to transmit HARQ ACK for other TBs instead.

Similarly, if an ACK/NACK is not received for a configured grant due to LBT failure, having the WTRU perform autonomous retransmissions (similar to NR-U) would be advantageous. However, HARQ feedback can only be sent in PSFCH for SL, the mechanism of a timer may not be well tailored to SL. For example, a mechanism of autonomous retransmissions in SL-U for CG may be introduced to address the possibility of the RX WTRU having LBT failure.

Finally, if autonomous retransmissions are performed by the TX WTRU, it may inform the network to avoid that the network schedule dynamic retransmissions in dynamic SL grants for a specific CG. For example, the network of an autonomous retransmission in a SL CG may be introduced to avoid unnecessary scheduling of SL dynamic grants by the network that may be unaware of a WTRU performing autonomous retransmissions.

Herein, a PSFCH resource may be considered as an occasion for transmission of HARQ feedback from an RX WTRU to a TX WTRU. This may refer to the existing PSFCH resources used for SL HARQ feedback. It may consider that multiple such resources can be configured for sending HARQ feedback to a singe WTRU. Alternatively or additionally, a PSFCH resource can refer to any occasion for an RX WTRU to send HARQ feedback. For example, if HARQ feedback is piggybacked on a transmission and/or sent using SCI, a PSFCH resource herein may refer to an occasion for transmission by the RX WTRU, an actual transmission by the RX WTRU, or the like.

Embodiments described herein based on the principle that ACK/NACK feedback transmitted by the RX WTRU in SL-U may be costly in some cases (e.g., they require LBT), therefore further embodiments where the ACK/NACK feedback is not transmitted, especially for CG, may be useful.

In examples or embodiments described herein, assumption of an ACK may further include the transmitter (TX) WTRU's reporting ACK on PUCCH to the network. Similarly, assumption of a NACK may further include the transmitter WTRU's reporting NACK on PUCCH to the network.

Another principle described herein is that because of the possibility of failed LBT by the RX WTRU when transmitting HARQ feedback, the RX WTRU may be configured with multiple PSFCH resources. To ensure resources are used efficiently, a many to one mapping of TB transmissions to PSFCH resources may be ensured in this case. Finally, if the TX WTRU can implicitly determine ACK/NACK, some prioritization of the multiple pending HARQ ACK/NACK feedbacks at an RX WTRU may be performed to avoid ACK to NACK or NACK to ACK assumption/error.

Embodiments for SL CG Implicit ACK/NACK are described herein.

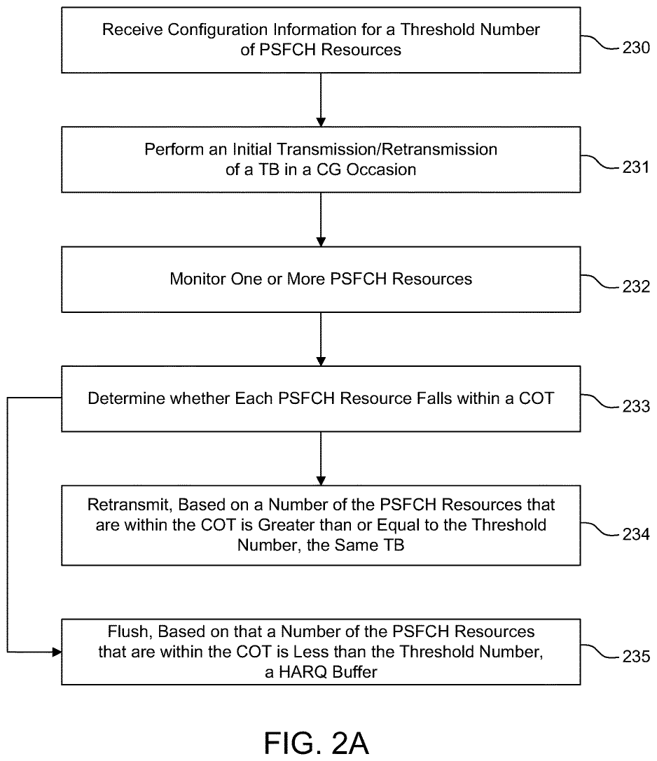

In embodiments, a TX WTRU may determine whether to assume NACK and perform retransmission of a TB in a configured grant (CG) occasion, or whether to assume ACK and perform a new transmission of another TB using the same HARQ process based on the number of PSFCH resources associated with the transmission which fall within a COT initiated/used by the TX WTRU. FIG. 2A illustrates an example process for SL CG implicit ACK and/or NACK. In embodiments, at 230 TX WTRU may receive a configuration (or configuration information) for a threshold number of PSFCH resources. At 231, the TX WTRU may perform an initial transmission or retransmission of a TB in a CG occasion. At 232, the TX WTRU may monitor one or more PSFCH resources associated with the CG transmission resource, and determine whether each PSFCH resource falls within the COT initiated by the TX WTRU. If the number of PSFCH resources associated with the CG transmission resource that are within a COT initiated/used by the TX WTRU is higher than the threshold and the WTRU has not received ACK/NACK from the RX WTRU for the transmission, at 234 the TX WTRU may perform retransmission of the same TB in the next CG occasion. Otherwise if ACK/NACK is not received, at 235, the TX WTRU may lush the HARQ buffer, assume ACK, and use the HARQ process for transmission of a new TB in the next CG occasion.

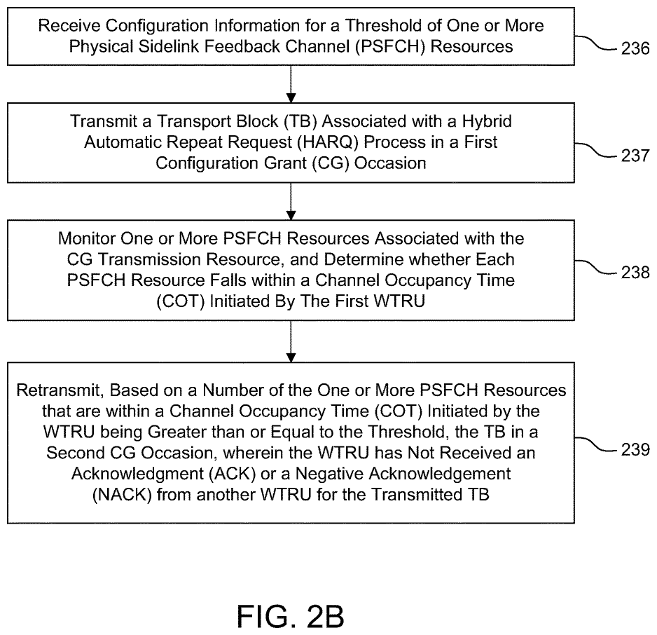

In a further embodiment described for example in FIG. 28 at 236 a WTRU may receive configuration information for a threshold of one or more physical sidelink feedback channel (PSFCH) resources. At 237, the WTRU may transmit a transport block (TB) associated with a hybrid automatic repeat request (HARQ) process in a first configured grant (CG) occasion. At 238, the TX WTRU may monitor one or more PSFCH resources associated with the CG transmission resource, and determine whether each PSFCH resource falls within the COT initiated by the TX WTRU. At 239, the WTRU may retransmit the TB in a second CG occasion, in response to a number of the one or more PSFCH resources that are within a channel occupancy time (COT) initiated by the WTRU being greater than or equal to the threshold, wherein the WTRU has not received an acknowledgment (ACK) or a negative acknowledgement (NACK) from another WTRU for the transmitted TB.

In embodiments, a WTRU may assume ACK/NACK following absence of PSFCH transmission by the peer WTRU.

In one embodiment, a TX WTRU may assume that absence of PSFCH reception from the peer WTRU to HARQ enabled transmission using a CG may represent ACK. Similarly, a TX WTRU may assume that absence of PSFCH reception from the peer WTRU to HARQ enabled transmission using a CG may represent NACK. Specifically, if the TX WTRU assumes ACK, the TX WTRU may, following the PSFCH resource where neither ACK or NACK is received, flush the HARQ buffer for the corresponding HARQ process. Additionally, at the next CG occasion allowing transmission for that HARQ process, the TX WTRU may transmit a new TB for the transport block. Similarly, if the TX WTRU assumes NACK, the TX WTRU may, following the PSFCH resource where neither ACK or NACK is received, enable a retransmission for the same TB associated with the HARQ process. The TX WTRU may perform the retransmission at the next CG occasion assonated with the HARQ process. Alternatively, or additionally, the TX WTRU may perform the retransmission on a dynamic grant provided by the network or allocated by the WTRU (e.g., in the case of mode 2). Alternatively, or additionally, the TX WTRU may perform the retransmission on a CG associated with transmission of a HARQ process (e.g., autonomous retransmission), as described further herein.

The assumption of ACK/NACK and conditions related to such are described herein for CG transmissions, but may apply as well to dynamic (e.g., one shot) transmissions associated with mode 1 or mode 2, or periodic transmissions performed by a WTRU in a periodic resource selected using mode 2.

The conditions for assuming ACK/NACK are described below. In any of the example, it is also understood that the conditions for assuming ACK vs NACK upon not receiving any feedback can be reversed.

In some embodiments, whether the WTRU assumes ACK or NACK based on a specific condition may further depend on other aspects of the transmission, such as QoS, LCH, SL measurements (e.g., CBR, RSRP, CR, etc.), past/current LBT results by the TX WTRU, COT length, or other factors described herein.

In the conditions for assuming ACK/NACK described below, combinations of conditions are also possible. Specifically, ACK/NACK may be assumed if a first condition and/or a second condition is met. Specifically, one condition may be used to determine the threshold, or whether to check a second condition or not.

In embodiments, the WTRU may assume ACK/NACK based on whether PSFCH resource(s) fall in a shared COT. In one embodiment, a WTRU may assume ACK/NACK based on whether one or more PSFCH resource is in a shared COT, either initiated by the TX WTRU, or initiated by another WTRU and possibly can be shareable by the RX WTRU. The TX WTRU may make the determination of whether the PSFCH falls in a shared/shareable COT for the RX WTRU based on the L2 ID and/or other information included in the COT information that can be decoded by the RX WTRU. Alternatively, or additionally, the TX WTRU may assume all COTs whose duration includes the PSFCH resource can be considered as sharable. Alternatively, or additionally, the TX WTRU may assume a shared/shareable COT is a COT initiated by the TX WTRU only. Other methods for determining a shared/shareable COT that can be used/usable by the RX WTRU are not precluded.

In one example which assumes a single PSFCH resource for a transmission, the TX WTRU may assume NACK if the PSFCH resource falls in a shared COT. The TX WTRU may further assume ACK if PSFCH resource does not fall in a shared COT. The advantage of such example is that it may allow the RX WTRU to not have to initiate LBT for COT transmission to simply send ACK to a CG. Alternatively, or additionally, the TX WTRU may assume ACK if PSFCH resource falls in a shared COT. The TX WTRU may further assume NACK if PSFCH resource does not fall in a shared COT.

In another example which assumes multiple PSFCH resources for each transmission, the TX WTRU may assume ACK/NACK if the number of PSFCH resources falling in a shared COT is above a specific number (e.g., a configured threshold number, a configured percentage of the number of PSFCH resources configured for each transmission). Specifically, the TX WTRU may assume NACK if at least x of the PSFCH resources fall within a shared COT and the TX WTRU did not receive ACK/NACK from the RX WTRU. The TX WTRU may further assume ACK if there is less than x PSFCH resources which fall in a shared COT and the TX WTRU did not receive ACK/NACK from the RX WTRU. Similarly, the TX WTRU may assume NACK if at least x % of the PSFCH resources fall within a shared COT and the TX WTRU did not received ACK/NACK from the RX WTRU. The TX WTRU may further assume ACK of there is less than x % of the PSFCH resource associated with the transmission which fall in a shared COT and the TX WTRU did not receive ACK/NACK from the RX WTRU.

In any of the above embodiments, x, x %, y %, etc., may be configured by the network, determined based on PC5-RRC exchange, and/or further depend on SL measurements, number of unicast inks, congestion (CBR, CR, etc.).

In embodiments, a WTRU may assume ACK/NACK based on other COT initiation or transmission by the RX WTRU. In one embodiment ACK/NACK may be assumed based on the presence of a transmission by the RX WTRU or a COT initiated by the RX WTRU, possibly overlapping with one or more of the PSFCH resources associated with the transmission performed by the TX WTRU.

In an embodiment where a WTRU may assume ACK/NACK based on other COT initiation or transmission by the RX WTRU, if at least one PSFCH resource falls in a COT initiated by the RX WTRU, possibly initialed after the transmission time, and the TX WTRU does not receive ACK/NACK, the TX WTRU may assume NACK. If there is no COT initiated by the RX WTRU that happens to overlap with a PSFCH resource associated with the transmission, the TX WTRU may assume ACK.

In an embodiment where a WTRU may assume ACK/NACK based on other COT initiation or transmission by the RX WTRU, if at least one, or at least a configured number of PSFCH resource occur(s) in a time which is adjacent to a transmission by the RX WTRU, where such transmission may include any SL transmission (e.g. transmission to the same WTRU, transmission to another WTRU, transmission of data, transmission of SSB, etc.), and the TX WTRU does not received ACK/NACK from the RX WTRU in (any of) the PSFCH resource(s), the TX WTRU may assume NACK. Furthermore, if there is less than a configured number of PSFCH resource(s) in a time which is adjacent to a transmission by the RX WTRU and the TX WTRU does not receive ACK/NACK from the RX WTRU, the TX WTRU may assume ACK. In the above example, an adjacent transmission may include a transmission in the same slot as the PSFCH resource, a transmission occurring immediately before/after the PSFCH resource, a transmission which occurs at most a specific time/frequency distance from a PSFCH resource, etc.

A WTRU may assume ACK/NACK based on measurements of SL In one embodiment, ACK/NACK may be assumed based on measurements of the SL resources, possibly those associated with the PSFCH resource(s), or resources occurring before/after the PSFCH resources, etc. Specifically, if a measurement of the SL resources meets a specific condition, the TX WTRU may assume ACK/NACK. Such measurement may include, but are not limited to, any of RSSI, CBR, RSRP, sensing based measurement (e.g., SCI RSRP), and the like. For example, if the TX WTRU measures at least one SCI with RSRP>threshold that is adjacent to one or more PSFCH resource associated with the transmission, the TX WTRU may assume NACK. Similarly, if the TX WTRU does not measure any SCI with RSRP>threshold and the TX WTRU does not receive ACK/NACK, the TX WTRU may assume ACK. In a further example, if the TX WTRU measured the RSSI of the channel>threshold in any/all resource(s) adjacent to one or more PSFCH resources, and the TX WTRU did not receive ACK/NACK from the RX WTRU, the TX WTRU may assume ACK. Otherwise, if the TX WTRU measured the RSSI of the channel<threshold in any/all such resource(s), the TX WTRU may assume NACK. In a further example, if the TX WTRU measures the CBR>threshold and does not receive ACK/NACK in (any) PSFCH resource associated with the transmission, the TX WTRU may assume NACK. Otherwise, if the CBR<threshold and the TX WTRU does not receive PSFCH, the TX WTRU may assume ACK.

A WTRU may assume ACK/NACK based on LBT success/failure by the TX WTRU. In one embodiment, ACK/NACK may be assumed based on success of failure of an LBT procedure performed by the TX WTRU. Such procedure may be performed for accessing the channel for transmission by the TX WTRU. Alternatively, or additionally, such procedure may be performed solely for determining the availability of the channel for determination of ACK/NACK by the TX WTRU. For example, if the TX WTRU determines that LBT is successful for one or a threshold number of PSFCH resources associated with the transmission, and the TX WTRU does not receive HARQ feedback from the RX WTRU, the TX WTRU may assume ACK. Otherwise, if the TX WTRU is not successful in performing LBT at the time of one or more or all PSFCH resources and the TX WTRU does not receive HARQ ACK, the TX WTRU may assume NACK.

A WTRU may assume ACK/NACK based on reception of ACK/NACK associated with other WTRU transmissions. In one embodiment, ACK/NACK may be assumed based on the reception, by the TX WTRU, of HARQ ACK/NACK transmissions by the TX WTRU but intended to other WTRU transmissions, or other HARQ process transmissions by the same TX WTRU. For example, if the TX WTRU receives ACK/NACK associated with another TB transmission associated with another HARQ process, the TX WTRU may assume ACK to the original TB transmission. The TX WTRU may assume such HARQ feedback when another TB transmission occurs with some time relationship compared to the original TB transmission (e.g., some time after the original TB transmission). In a further example, if the TX WTRU receives ACK/NACK intended to another WTRU from the RX WTRU using the same PSFCH resources associated with the TX UEs transmission, the TX WTRU may assume ACK.

Embodiments for RX WTRU prioritization of HARQ feedback for SL CG are described herein. For example, an RX WTRU performing ACK/NACK transmissions in a multi-feedback PSFCH resource may prioritize transmission of ACK/NACK to specific WTRUs based on the type of feedback (e.g., ACK or NACK), priority, and the number of past PSFCH occasions that were usable (e.g., within the COT initiated/used by the TX WTRU) to send PSFCH to the peer WTRU. Specifically, an RX WTRU may receive a configuration (or configuration information) for a per-priority threshold number of PSFCH resources. The WTRU may receive a TB on a CG from a TX WTRU with an associated priority. If it has one or more HARQ transmissions pending, the WTRU may acquire the channel at the time of a PSFCH occasion. When the number of pending HARQ transmissions exceeds the HARQ feedback capacity of the PSFCH resource, the WTRU may prioritize PSFCH transmissions to the different WTRUs as follows. First, the WTRU may perform any pending HARQ ACK transmissions to WTRUs where the number usable PSFCH resources has reached the threshold. The WTRU may then perform any pending HARQ NACK transmissions to WTRUs where the number of usable PSFCH resources has not reached the threshold.

In one embodiment, an RX WTRU may prioritize transmission of SL HARQ feedback based on one or more prioritization criteria. Prioritization of HARQ feedback criteria, as discussed herein, may include, but are not limited to: transmit HARQ feedback associated with a TB using higher TX power, compared to other transmissions or other HARQ feedback; transmit HARQ feedback for one TB/WTRU before transmitting HARQ feedback for another TB/WTRU; transmit HARQ feedback for one TB/WTRU instead of transmitting HARQ feedback for another TB/WTRU; transmit HARQ feedback for one TB/WTRU instead of not transmitting HARQ feedback for that TB/WTRU at al; and/or use a different LBT criteria for accessing the channel and/or sharing an existing COT for transmitting HARQ feedback for one TB.

For example, an RX WTRU may be configured with multiple PSFCH resources associated with a singe TB and may prioritize HARQ feedback transmission on one of those PSFCH resources compared to the other ones.

For example, an RX WTRU may be configured with one or more PSFCH resources where a specific PSFCH resource may be usable for sending HARQ feedback to multiple TX WTRUs/TBs or a singe PSFCH resource may be associated with multiple TBs but usable for only transmission of a subset of HARQ ACK/NACK transmissions. In such a case, an RX WTRU may be in a situation where it may have a number of pending HARQ feedback transmissions that exceeds the capacity of the PSFCH resource. In such case, the RX WTRU may perform a prioritization of PSFCH based on conditions described herein.

Prioritization criteria herein may be applied to determining an ordered list of WTRU's or TBs based on such criteria. Specifically, the WTRU may order selection of the TB/WTRU to which HARQ feedback is sent on a specific resource by choosing the TB/WTRU that satisfies a first condition first, then, if transmission of additional HARQ feedback is possible, may choose the TB/WTRU that satisfies a second condition next, and so on, until transmission of additional HARQ feedback is not possible.

Prioritization criteria described herein may be applied to determining whether HARQ feedback for a TB/WTRU should be prioritized (e.g., transmitted with different LBT acquisition/sharing rules, higher power, etc.).

Prioritization criteria described herein may be applied to determining whether HARQ feedback for a TB/WTRU is transmitted or not.

Combinations of prioritization criteria are also possible, such as prioritizing a TB/WTRU that satisfies a first and second criteria, prioritizing a TB/WTRU that satisfies a first or second criteria, etc.

Embodiments for prioritization criteria are described here. A WTRU may prioritize HARQ feedback transmission based on ACK or NACK. In one embodiment, a WTRU may prioritize HARQ feedback transmission based on whether the HARQ feedback transmission is ACK or NACK. Specifically, the WTRU may prioritize ACK instead of NACK. Alternatively, or additionally, the WTRU may prioritize NACK instead of ACK.

A WTRU may prioritize HARQ feedback transmission based on number of remaining PSFCH resources that can be used to transmit HARQ feedback. In one embodiment, a WTRU may prioritize HARQ feedback transmission based on the number of remaining PSFCH resources that can be used to transmit HARQ feedback. For example, an RX WTRU may be configured with N PSFCH resources which can be used to send ACK/NACK to a TX WTRU for a specific TB. The RX WTRU may prioritize transmission of HARQ feedback if the number of remaining PSFCH resources remaining for sending HARQ feedback is below a configured threshold, if the PSFCH resource is associated with the last possible resource for sending HARQ feedback for that TB/WTRU, if the number of PSFCH resources which could have been used and were not used is above a configured threshold, etc.

A WTRU may prioritize HARQ feedback transmission based on number of remaining PSFCH resources until an expected retransmission by the TX WTRU. In one embodiment, a WTRU may prioritize HARQ feedback transmission based on the number of remaining PSFCH resources until an expected retransmission by the TX WTRU can occur. For example, an RX WTRU may prioritize HARQ feedback transmissions if the number of remaining PSFCH resources until an expected retransmission by the TX WTRU can occur is below a configured threshold. For example, an RX WTRU may prioritize HARQ feedback transmissions if the corresponding PSFCH resource is the last resource before a TX WTRU can perform HARQ retransmissions.

An RX WTRU can learn/determine when a TX WTRU can perform retransmissions based on signaling with the TX WTRU. For example, the TX WTRU may send the CG configurations, or information of the configured grant configurations to the RX WTRU, including which CG resource a TX WTRU can use for (e.g., autonomous) retransmission associated with another CG.

The advantage of such an approach is that the RX WTRU can reflect a HARQ ACK to the TX WTRU before the TX WTRU performs autonomous retransmissions.

A WTRU may prioritize HARQ feedback transmission based on whether the TX WTRU is configured with autonomous retransmissions. In one embodiment, an RX WTRU may prioritize HARQ feedback transmissions when the TX WTRU is configured with autonomous retransmissions. Specifically, the RX WTRU may determine (e.g., based on reception of such information in PC5-RRC signaling or based on NW configuration in Uu RRC) from the TX WTRU that the TX WTRU can perform autonomous retransmissions. The RX WTRU may then prioritize HARQ feedback transmissions associated with that WTRU when that WTRU has autonomous retransmissions enabled.

A WTRU may prioritize HARQ feedback transmission based on number of remaining PSFCH resources until a future reserved resource by the TX WTRU. In one embodiment which assumes the TX WTRU performs mode 2 resource allocation, an RX WTRU may prioritize HARQ feedback transmissions based on how many remaining PSFCH resources which can be used for sending HARQ feedback for a TB will occur prior to a future reserved resource by the TX WTRU. For example, if the RX WTRU has only one PSFCH resource for sending HARQ feedback to a TX WTRU prior to the next reserved resource (e.g., indicated by the TX WTRU using a resource reservation indication in SCI), the RX WTRU may prioritize that HARQ feedback. For example, if the number of PSFCH resources that can be used for sending HARQ feedback to the TX WTRU prior to the TX WTRU's next reserved resource is below a threshold, the RX WTRU may prioritize the HARQ feedback.

A WTRU may prioritize HARQ feedback transmission based on number of remaining PSFCH resources compared to a configured/agreed threshold number. In one embodiment, a WTRU may prioritize HARQ feedback transmission based on the number of remaining PSFCH resources compared to a defined amount. For example, if the number of remaining PSFCH resources associated with a TB is smaller than a configured threshold, the RX WTRU may prioritize HARQ feedback. The threshold may be configured by the network, the peer WTRU, or negotiated between the WTRUs via PC5-RRC signaling. For example, the RX WTRU may prioritize HARQ feedback in the last available PSFCH resource for that TB. For example, the RX WTRU may prioritize HARQ feedback if the number of remaining PSFCH resources is less than x (configured) %.

A WTRU may prioritize HARQ feedback transmission based on whether the PSFCH transmission requires initiation of a COT using LBT. In one embodiment, a WTRU may prioritize HARQ feedback transmission based on whether the HARQ feedback can be sent with/without the RX WTRU initiating a COT. For example, if the RX WTRU uses an existing COT (i.e., COT sharing) to send PSFCH, the RX WTRU may prioritize the HARQ feedback. Conversely, if the RX WTRU needs to initiate a COT to transmit the HARQ feedback at the PSFCH resource, the RX WTRU may prioritize transmission of the HARQ feedback.

The RX WTRU may further prioritize HARQ feedback based on the LBT rules to be used/required to transmit the PSFCH. For example, if one type of LBT (rather than another) can be used to transmit the PSFCH, the WTRU may prioritize the HARQ feedback transmission.

The RX WTRU may further prioritize HARQ feedback based on whether the COT to be shared by the RX WTRU for transmission of the PSFCH is a COT initiated by the TX WTRU or another WTRU. For example, the RX WTRU may prioritize transmission of HARQ feedback in a COT shared by the RX WTRU which was initiated by the TX WTRU. Alternatively, or additionally, the RX WTRU may prioritize transmission of HARQ feedback in a COT shared by the RX WTRU which was initiated by a WTRU other than the TX WTRU.

Embodiments for SL CG retransmission at the TX WTRU are described herein. For example, a TX WTRU may perform autonomous retransmission of a TB on a SL CG based on the priority and the number of associated PSFCH resources where it did not receive HARQ feedback. Specifically, a TX WTRU may receive a configuration for a per-priority minimum number of PSFCH resources elapsed allowing re-transmission. The TX WTRU may perform an initial transmission or a retransmission on a SL CG resource associated with the HARQ process. The TX WTRU may monitors multiple PSFCH resources associated with the SL CG resource. When the number of PSFCH resources in which HARQ feedback can be received and is not received for the TB exceeds the threshold configured for the priority of the TB, the TX WTRU may perform retransmissions of the TB on another CG other than the one associated with the HARQ process.

In one embodiment, a TX WTRU may perform autonomous transmission of a TB on a SL CG. Specifically, following a first TB transmission, a TX WTRU may decide whether to perform retransmission of the TB prior to the reception of any HARQ feedback (e.g., ACK or NACK) by the RX WTRU. The TX WTRU may perform such autonomous retransmissions in another CG resource, potentially that is not associated with the CG resource which allows the HARQ process to be transmitted. Alternatively or additionally, a TX WTRU may perform such autonomous retransmissions in a dynamic grant Specifically, the initial transmission may include a transmission in a periodic resource using mode 2, and the retransmission may be associated with a one shot dynamic resource selected by the TX WTRU. Specifically, the TX WTRU may require that a specific condition is met before a retransmission is performed in a dynamic grant. Specifically, the initial transmission may include a transmission in a CG, and the retransmission may be associated with a dynamic grant provided by the network. In other words, the WTRU may not be allowed to perform retransmission of TB in a dynamic grant until a specific condition is met. In such autonomous retransmissions, the TX WTRU may further indicate the HARQ process ID associated to the TB, to inform the RX WTRU that it is sending a retransmission for a specific HARQ process. Such may be required, for example, in the case where the CG resource typically allows transmission of only certain HARQ process IDs.

The conditions for retransmission may include minimum requirements to be satisfied for a TX WTRU to perform a retransmission of a CG. Specifically, the TX WTRU may be allowed to perform retransmission any time after the condition is satisfied. Alternatively or additionally, the conditions for retransmission may include the exact requirements to be satisfied by a TX WTRU. Specifically, the TX WTRU may perform retransmission following satisfying a condition. Alternatively or additionally, the same conditions can act as conditions for a TX WTRU to request for a retransmission resource from the network (e.g., through transmission of PUCCH, SL-SR, SL-BSR, etc.). Alternatively or additionally, the same conditions can act as conditions for the TX WTRU to perform resource (re)selection (e.g., to select a one shot resource to be used for a retransmission, in the case of mode 2.

Combinations of conditions are also possible. Specifically, autonomous retransmissions may be allowed only if condition 1 and 2 are satisfied. Specifically, autonomous retransmissions may be allowed when condition 1 or condition 2 is satisfied. Specifically, a condition for autonomous retransmission may be specified in terms of a threshold or quantity, where the threshold/quantity depends on another condition.

A WTRU that performs autonomous retransmission as a result of satisfying a condition may perform retransmission of a TB on a CG other than the CG associated with that HARQ process. On the other hand, if a condition is not met, the WTRU may be required to wait for a dynamic grant, or a CG associated with the HARQ process to perform the retransmission.

Embodiments for conditions for retransmission are described herein. A WTRU may perform autonomous retransmission based on the number of PSFCH resources. In one embodiment, a WTRU may perform autonomous retransmission based on the number of PSFCH resources that have elapsed, possibly without receiving HARQ ACK/NACK. Specifically, the WTRU may perform autonomous HARQ retransmissions after a configured number of PSFCH resources have elapsed, possibly without having received HARQ ACK/NACK from the RX WTRU. In one example, the WTRU may perform autonomous HARQ retransmissions if the number of remaining PSFCH resources that can be used to send HARQ feedback for the TB is lower than a threshold. In another example, the WTRU may perform autonomous HARQ retransmissions if there are no remaining PSFCH resources that can be used for the RX WTRU to send HARQ feedback, possibly in combination with another condition herein.

A WTRU may perform autonomous retransmission based on the QoS. In one embodiment, a WTRU may perform autonomous retransmission based on the QoS of the initial transmission. For example, if the priority of the transmission is above a threshold, a TX WTRU may be allowed to perform autonomous retransmissions, and may not do so otherwise. For example, a TX WTRU may be configured with a different condition or criteria, based on the conditions/criteria herein (e.g., a different number of PSFCH resources, possibly within a shared COT) per priority of initial transmission before the TX WTRU is allowed to perform a retransmission. For example, the number of autonomous retransmissions a WTRU can perform may be configured per QoS/priority.

A WTRU may perform autonomous retransmission based on whether PSFCH resource falls inside a COT. In one embodiment, a WTRU may perform autonomous retransmission based on whether one or more PSFCH resources (e.g., possibly a specific number as per herein) are within a COT which can be used by the RX WTRU to send HARQ feedback to the TX WTRU (i.e., a usable PSFCH resource in COT that can be shared by the RX WTRU). For example, a WTRU may perform autonomous retransmissions following a PSFCH resource where HARQ ACK/NACK is not received, and the PSFCH resource falls within a COT that the RX WTRU can share. For example, the TX WTRU can perform autonomous retransmissions after a configured number of PSFCH resources associated with the TB have been determined to be located within a COT shareable by the TX WTRU. For example, a WTRU may perform autonomous retransmission following a number of PSFCH resources associated with a COT initiated by the TX WTRU or initiated by another WTRU.

A WTRU may perform autonomous retransmission based on PUCCH configuration. In one embodiment, a WTRU may perform autonomous retransmissions-based conditions associated with the PUCCH configuration. For example, if the TX WTRU is configured without PUCCH resources, the TX WTRU may perform autonomous retransmissions. Alternatively, or additionally, the time in which the TX WTRU can perform autonomous retransmissions may be based on the timing of a configured PUCCH resource. For example, the TX WTRU can perform autonomous retransmission for a CG following a PUCCH resource configured for sending ACK/NACK to the network for that CG. For example, the TX WTRU can perform autonomous retransmission for a CG at any time following the last PUCCH resource configured for sending ACK/NACK to the network for that CG.

A WTRU may perform autonomous retransmission based on SL measurements. In one embodiment, whether a WTRU can perform autonomous retransmissions may depend on conditions related to SL measurements, such as SL RSSI, SL CBR, SL CR SL RSRP (e.g., measured with the peer WTRU), or the like. For example, a WTRU can perform autonomous retransmissions if the measured CBR is below a threshold. For example, a WTRU can perform autonomous retransmissions if the average RSSI measured on sidelink is below a threshold.

In another embodiment, thresholds, parameters, configured numbers, or the like that is/are associated with other example embodiment herein may further be dependent on SL measurements.

A WTRU may perform autonomous retransmission based on whether transmission has HARQ feedback enabled/disabled. In one embodiment, whether a WTRU can perform autonomous retransmission may depend on whether the initial transmission was sent with HARQ feedback enabled/disabled. For example, autonomous retransmissions may only be performed for HARQ feedback disabled transmissions. In another example, a WTRU may maintain a CG retransmission timer and may only start such timer when performing a transmission with HARQ feedback enabled.

In another embodiment, a WTRU may use different conditions described herein for determining whether/when to perform autonomous retransmissions for HARQ enabled transmissions compared to HARQ disabled transmissions.

Embodiments for reporting (to the network) of autonomous retransmissions by the TX WTRU are described herein. For example, an TX WTRU may inform the network of a decision to perform autonomous retransmission associated with a SL HARQ process by including the HARQ process ID in a MAC CE, and triggering SR if the WTRU does not have an UL grant scheduled within a configured time of the SL CG resource used for the transmission. Specifically, a TX WTRU may receive a configuration for a threshold time between SL CG resource and UL grant. The TX WTRU may be configured with one or more SL CG. If TX WTRU determines to perform retransmission for a HARQ process in a SL CG resource that is different than the resource configured for the HARQ process (e.g., autonomous retransmission on SL configured grant), the TX WTRU may include the HARQ process ID of the retransmission performed in a CG resource in a MAC CE and transmit the MAC CE in the next available UL resource. If the time between the SL CG resource used for the retransmission and the next available UL grant is above a threshold, the TX TWRU may trigger SR associated with the highest priority UL LCH.

A WTRU may inform the network of a decision to perform autonomous retransmission. In one embodiment, a WTRU may perform autonomous retransmission associated with a SL HARQ process in a CG (i.e., a CG other than the one associated with the HARQ process), and may inform the network of such. Specifically, a WTRU may transmit a message in UL (e.g., a MAC CE, an RRC message, an SR, a PUCCH, or the like), upon the decision to perform an autonomous retransmission. Such transmission may include, but are not limited to: the HARQ process ID of the retransmission; the CG used to perform the retransmission, or some indication of the SL resource used to perform the retransmission; and/or the reason for (or condition met) for performing the autonomous retransmission.

For example, a WTRU may decide to perform an autonomous retransmission for a CG on sidelink using a different CG resource. The WTRU may inform the network in a MAC CE of the HARQ process for which the WTRU performed an autonomous retransmission, and the timing if the SL resource that was used for the retransmission.

A WTRU may determine a time frame for informing the network of an autonomous retransmission. A WTRU may determine a time frame for when (e.g., a maximum time) to inform the network of having performed an autonomous retransmission. In one example, a WTRU may be configured with a predetermined PUCCH resource for indicating that an autonomous retransmission is performed. Such predetermined PUCCH resource may be located in a slot with a predefined relation to the CG on which the retransmission is performed and/or the HARQ process for which the autonomous retransmission is performed.

In another example, a WTRU may be configured with a maximum time between the time the event of autonomous retransmission (e.g., the time in which the autonomous retransmission is performed, the PUCCH resource associated with indicating HARQ feedback for the initial retransmission, or the like) and the time in which the WTRU may inform the network. Specifically, such time may be to avoid the network configured a dynamic grant. For example, the WTRU may transmit a MAC CE in a grant which occurs within the configured grant. If the WTRU does not have a pending grant within the window at the time of the autonomous retransmission, the TX WTRU may trigger autonomous UL transmission (e.g., RACH, SR, SIB request, or the like). For example, the WTRU may trigger SR associated with the highest available LCH configured with SR.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method performed by a first WTRU for sidelink (SL) communication with a second WTRU comprising:
receiving configuration information for a threshold number of physical sidelink feedback channel (PSFCH) resources;
transmitting a transport block (TB) associated with a hybrid automatic repeat request (HARQ) process in a first configured grant (CG) occasion; and
retransmitting the TB in a second CG occasion, in response to a number of PSFCH resources that are within the channel occupancy time (COT) initiated by the WTRU being greater than or equal to the threshold number, wherein the WTRU has not received an acknowledgment (ACK) or a negative acknowledgement (NACK) from the second WTRU for the transmitted TB.

2. The method of claim 1, further comprising:
monitoring one or more PSFCH resources associated with the first CG grant occasion, and determining whether each PSFCH resource falls within a COT initiated by the first WTRU.

3. The method of claim 1, further comprising:
flushing, based on a number of PSFCH resources that are within the COT initiated by the WTRU being less than the threshold number and the WTRU has not received the ACK or the NACK, a HARQ buffer; and
transmitting, using the HARQ process, another TB in the second CG occasion.

4. The method of any of claim 1, wherein the one or more PSFCH resources are one or more occasions to receive, from the second WTRU, one or more HARQ feedback.

5. The method of claim 4, wherein the one or more HARQ feedback are one or more sidelink HARQ feedback.

6. The method of claim 1, wherein the WTRU assumes a receipt of a NACK for the transmitted TB in response to a number of PSFCH resources that are within the COT initiated by the WTRU being greater than or equal to the threshold number.

7. The method of claim 1, wherein the WTRU assumes a receipt of an ACK for the transmitted TB in response to a number of PSFCH resources that are within the COT initiated by the WTRU being less that the threshold number.

8. A wireless transmit/receive unit (WTRU) comprising:
a processor;
a receiver; and
a transmitter,
the processor and the receiver configured to receive configuration information for a threshold number of physical sidelink feedback channel (PSFCH) resources; and
the processor and the transmitter configured to:
transmit a transport block (TB) associated with a hybrid automatic repeat request (HARQ) process in a first configured grant (CG) occasion; and
the processor and the transmitter further configured to retransmit the TB in a second CG occasion, in response to a number of PSFCH resources that are within a channel occupancy time (COT) initiated by the WTRU being greater than or equal to the threshold number, wherein the WTRU has not received an acknowledgment (ACK) or a negative acknowledgement (NACK) from the second WTRU for the transmitted TB.

9. The WTRU of claim 8, wherein the processor and the receiver are further configured to monitor one or more PSFCH resources associated with the first CG occasion, and determine whether each PSFCH resource falls within a COT initiated by the first WTRU.

10. The WTRU of claim 8, wherein the processor and the transmitter are further configured to:
flush, in response to a number of PSFCH resources that are within the COT initiated by the WTRU being less than the threshold number and the WTRU has not received the ACK or the NACK, a HARQ buffer; and
transmit, using a HARQ process, another TB in a second CG occasion.

11. The WTRU of claim 8 to 10, wherein the one or more PSFCH resources are one or more occasions to receive, from another WTRU, one or more HARQ feedback.

12. The WTRU of claim 11, wherein the one or more HARQ feedback are one or more sidelink HARQ feedback.

13. The WTRU of claim 8, wherein the processor is further configured to assume a receipt of a NACK for the transmitted TB in response to a number of PSFCH resources that are within the COT initiated by the WTRU being greater than or equal to the threshold number.

14. The WTRU of claim 8, wherein the processor is further configured to assume a receipt of an ACK for the transmitted TB in response to a number of PSFCH resources that are within the COT initiated by the WTRU being less that the threshold number.
